(19) United States
(12) Patent Application Publication
(10) Pub. No.: US 2019/0183616 A1
(43) Pub. Date: Jun. 20, 2019

(54) TOOTH CLEANING STRUCTURE

(71) Applicants: Yu-Ling Chung, Taichung City (TW); Pi-Kuei Chung, Taichung City (TW)

(72) Inventors: Yu-Ling Chung, Taichung City (TW); Pi-Kuei Chung, Taichung City (TW)

(21) Appl. No.: 15/846,211

(22) Filed: Dec. 19, 2017

(51) Int. Cl. A61C 15/02

(52) U.S. Cl. CPC A61C 15/02

(57) ABSTRACT

A tooth cleaning structure includes an elongate member. The elongate member includes a first section, a second section, and an intermediate section connected between the first section and the second section. The first section includes a tooth cleaning plate. The intermediate section has a thickness that is greater than thicknesses of the first section and the second section, so that the elongate member is elastically deformable and the intermediate section support the tooth cleaning plate to extend out in a flat form at an end of the elongate member. To use, a user may hold the intermediate section or the second section of the elongate member with the tooth cleaning plate being kept flat at an end of the elongate member to ease operation of insertion of the tooth cleaning plate into a slit between teeth of the user, with the tooth cleaning plate undergoing elastic deformation.

### (a) TECHNICAL FIELD OF THE INVENTION

The present invention generally relates to a tooth cleaning structure, which allows for easy operation to insert into a slit between teeth as undergoing elastic deformation in accordance with the slit between the teeth in order to facilitate the operation of picking or cleaning teeth, and more particularly to an elongate member and a tooth cleaning plate of the tooth cleaning structure.

### (b) DESCRIPTION OF THE PRIOR ART

It already known to use a toothpick that is in the form of an elongate slender stick having at least one end forming a sharp tip to pick teeth or to clean slits between teeth. An issue concerning structural design and use of such toothpick products is that the elongate slender stick configuration is generally made by following a structural arrangement and configuration that have been used for an extremely long time and the tip of the stick may not be easily inserted into the slim slits between teeth of a user and thus, damage of the slits of teeth and the gum of the user may easily occur and an effect of cleaning that can be achieved for slits between teeth may be reduced.

Further, a known structure of dental floss generally comprises a flat filament made of a flexible material. Such a flat filament can easily enter the slim slits between teeth of a user, but the flat filament is generally soft and must be used with both hands of the user to remove detritus or clean teeth. This cause troubles and inconvenience in operation and use. In view of these problems, the present invention aims to provide a tooth cleaning structure that helps overcome the above problems.

### SUMMARY OF THE INVENTION

Thus, the primary objective of the present invention is to provide a tooth cleaning structure, which comprises an elongate member, which comprises a first section, a second section, and an intermediate section connected between the first section and the second section. A tooth cleaning plate is provided on the first section. The intermediate section has a thickness that is greater than thicknesses of the first section and the second section, so that the elongate member is elastically deformable and the intermediate section support the tooth cleaning plate to extend out in a flat form at an end of the elongate member. With the above, during a use, the user may hold the intermediate section or the second section of the elongate member in such a way that the tooth cleaning plate is kept in a flat form at an end of the elongate member to ease an operation of insertion of the tooth cleaning plate into a slit between teeth of the user, wherein during the operation, the tooth cleaning plate may undergo elastic deformation in accordance with the slit of the teeth of the user in order to carry out tooth picking or cleaning so as to improve convenience and practical use and overcome the drawbacks that a tip of a toothpick may not be easily inserted into the slit of the teeth, may cause damage to the slit of the teeth and the gum, and also help improve the drawback that dental floss is excessively soft so as to be not easy to use.

Based on the above-described primary structural features, the second section is provided with a tooth cleaning tip or tooth cleaning plate and the tooth cleaning tip is configured as a curved tooth cleaning tip.

Based on the above-described primary structural features, the tooth cleaning plates of the first section and the second section are each configured as one of a flexible tooth cleaning plate and an elastic tooth cleaning plate.

Based on the above-described primary structural features, the intermediate section is configured as one of a connection board and a connection bar.

Based on the above-described primary structural features, the tooth cleaning plate is formed as one of a rectangular tooth cleaning plate, a polygonal tooth cleaning plate, a triangular tooth cleaning plate, a rhombus tooth cleaning plate, a partly curved tooth cleaning plate, a circular arc tooth cleaning plate, a fish-bone-shaped tooth cleaning plate, and an arc-curved tooth cleaning plate.

Based on the above-described primary structural features, a side portion of the rectangular tooth cleaning plate has a thickness that is reduced in a direction toward an opposite side portion of the rectangular tooth cleaning plate.

Based on the above-described primary structural features, a portion of the tooth cleaning plate that is distant from the intermediate section is formed as one of a notched edge and a serrated edge.

Based on the above-described primary structural features, the tooth cleaning plate has a thickness that is reduced from a portion of the tooth cleaning plate that is adjacent to the intermediate section toward a portion of the tooth cleaning plate that is distant from the intermediate section.

Based on the above-described primary structural features, the tooth cleaning plate has a surface that is formed with one of a group of multiple thin grooves and a group of multiple raised dots.

Based on the above-described primary structural features, the elongate member is arranged such that multiple ones thereof are provided with the first section and the second section of two adjacent ones of the multiple elongate members are connected together by means of a weakened easy-to-break section so that the multiple elongate members are windable as a roll.

Based on the above-described primary structural features, a surface of one of the connection board and the connection bar is provided with at least one rib extending in directions toward the first section and the second section.

The features of the present invention is that the two ends of the direction-change coupling member are respectively formed with the first coupling section and the second coupling section that are arranged in an angularly staggered manner and extend in different directions with the first coupling section and the second coupling section each connected with one connection members, wherein a first aluminum extrusion plate is provided to receive one of the connection members therethrough to be set at a location corresponding to the first coupling section and a second aluminum extrusion plate is provided to receive the other one of the connection members to extend therethrough to be set at a location corresponding to the second coupling section so that the first aluminum extrusion plate and the second aluminum extrusion plate are connected in an angularly staggered manner to form a connection module having and defining a corner. In this way, each of the connection members is allow to further couple to a pre-prepared aluminum extrusion piece, generally in the form of a plate also, to allow the two pre-pared aluminum extrusion pieces to respectively connect with the first aluminum extrusion plate and the second aluminum extrusion plate to allow an operator to carry out an installation operation as required to fast construct a corner connection between two aluminum extrusion plates and thus effectively reduce operation time of installation and fast complete a systematic structure.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment according to the present invention.

FIG. 1A is a side elevational view, in an enlarged scale, of the preferred embodiment of the present invention.

FIG. 2 is a schematic view showing an additional embodiment of FIG. 1.

FIG. 2A is a side elevational view, in an enlarged scale, of the additional embodiment of FIG. 2.

FIG. 3 is a schematic view showing another additional embodiment of FIG. 1.

FIG. 4 is a schematic view showing a further additional embodiment of FIG. 1.

FIG. 5 is a schematic view showing a further additional embodiment of FIG. 1.

FIG. 6 is a schematic view showing a further additional embodiment of FIG. 1.

FIG. 6A is an end view, in an enlarged scale, of the additional embodiment of FIG. 6.

FIG. 7 is a schematic view showing a modified embodiment of FIG. 1.

FIG. 7A is a side elevational view, in an enlarged scale, of the modified embodiment of FIG. 7.

FIG. 8 is a schematic view showing an additional embodiment of FIG. 7.

FIG. 8A is a side elevational view, in an enlarged scale, of the additional embodiment of FIG. 8.

FIG. 9 is a schematic view showing another modified embodiment of FIG. 1.

FIG. 9A is a side elevational view, in an enlarged scale, of the modified embodiment of FIG. 9.

FIG. 10 is a schematic view showing an additional embodiment of FIG. 9.

FIG. 10A is a schematic view, in an enlarged scale, showing a circled portion of FIG. 10.

FIG. 11 is a schematic view showing a modified embodiment of FIG. 9.

FIG. 12 is a schematic view showing an additional embodiment of FIG. 11.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

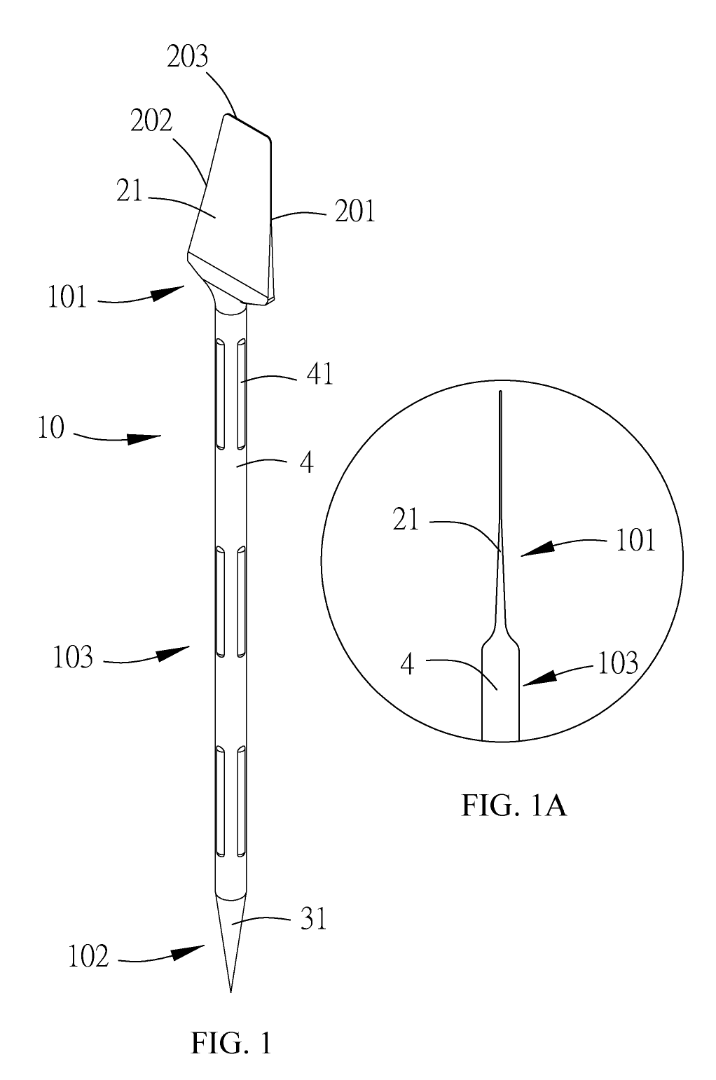

Referring to FIG. 1, as well as FIG. 1A, which is a drawing that discloses one way of embodying the present invention, the drawing illustrates a tooth cleaning structure according to the present invention comprises an elongate member 10. The elongate member 10 comprises a first section 101, a second section 102, and an intermediate section 103 connecting the first section 101 and the second section 102 to each other.

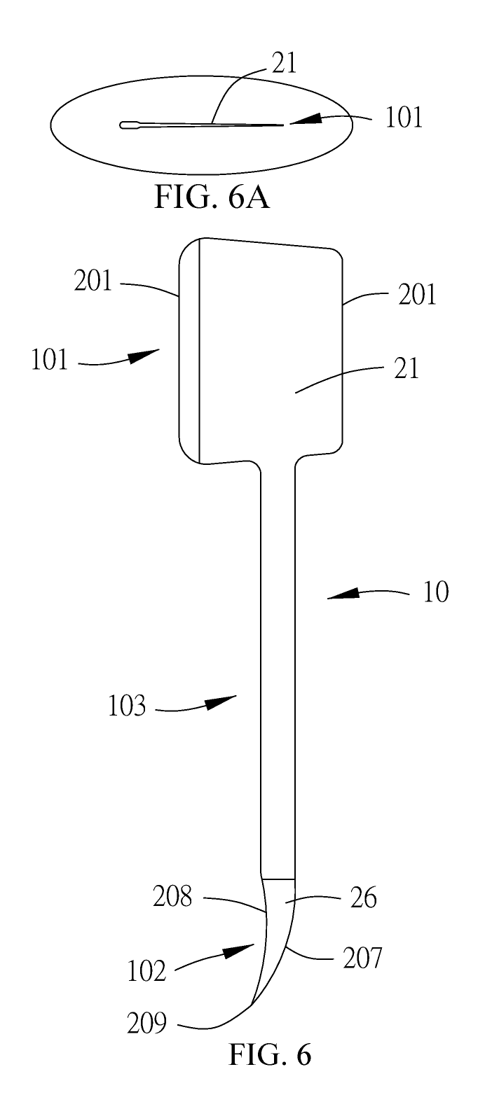

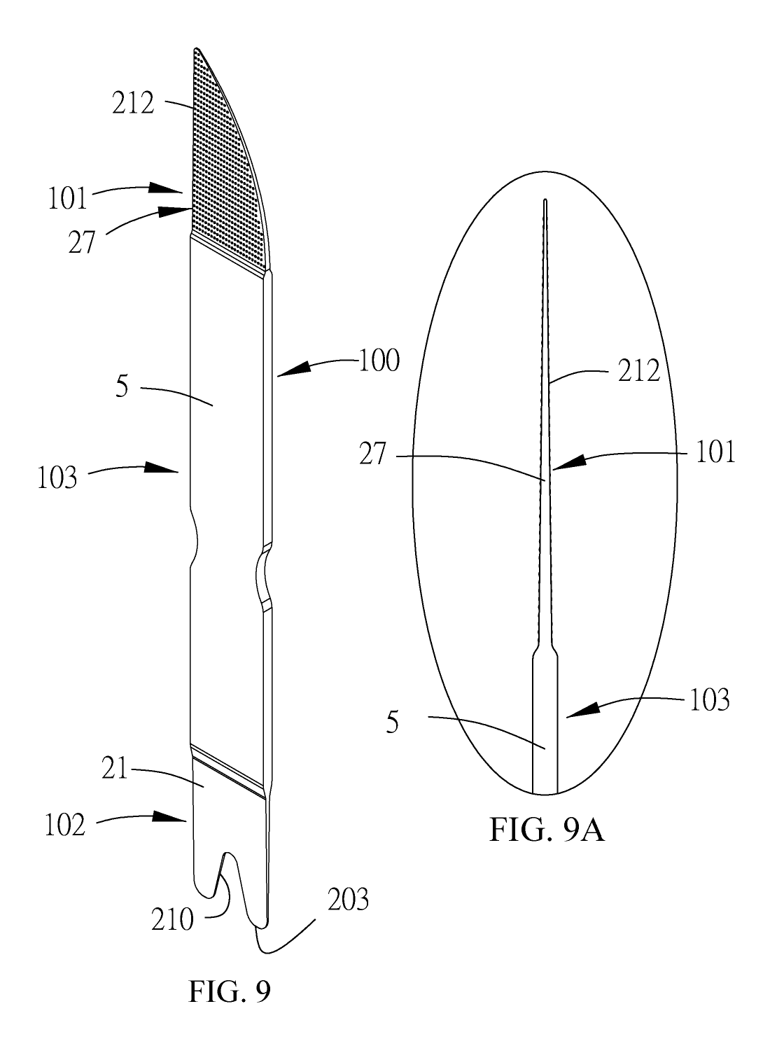

In the preferred embodiment adopted herein, the elongate member 10 is made of a plastic material demonstrating flexibility or elasticity. The first section 101 of the elongate member 10 is provided with a tooth cleaning plate 21. The second section 102 of the elongate member 10 may be additionally provided with a tooth cleaning plate 21 (as shown in FIGS. 6 and 9), such that the tooth cleaning plate 21 of the first section 101 or the second section 102 of the elongate member 10 is formed as a flexible tooth cleaning plate or an elastic tooth cleaning plate. The intermediate section 103 of the elongate member 10 has a thickness that is greater than thicknesses of the first section 101 and the second section 102 so that the elongate member 10 may demonstrate an effect of elastic deformation and would not get too difficult to handle and use as not being as soft as dental floss. In addition, the intermediate section 103 could support and maintain the tooth cleaning plate 21 to extend out, in a flat form, at one end of the elongate member 10.

FIG. 1 also shows that the tooth cleaning plate 21 can be configured as a rectangular tooth cleaning plate (such as a trapezoid) or a polygonal tooth cleaning plate (such as a pentagon or a hexagon), having two opposite sides respectively forming a vertical edge 201 and a slope edge 202. The tooth cleaning plate 21 is provided, at a portion thereof that is distant from the intermediate section 103, with a horizontal edge 203 connected between the vertical edge 201 and the slope edge 202. The tooth cleaning plate 21 has a thickness that is reduced or tapering from a portion of the tooth cleaning plate 21 that is adjacent to the intermediate section 103 in a direction toward a portion of the tooth cleaning plate 21 that is distant from the intermediate section 103 (which is a distal end of the tooth cleaning plate 21). The second section 102 of the elongate member 10 is formed with a tooth cleaning tip 31. The intermediate section 103 comprises a connection bar 4, and the connection bar 4 has two ends that are respectively connected to the tooth cleaning plate 21 and the tooth cleaning tip 31. The connection bar 4 has a surface that is provided with at least one rib 41 thereon to extend in a direction toward the first section 101 and the second section 102 in order to increase a structural strength of the connection bar 4.

It is appreciated that to use, a user may hold the connection bar 4 of the intermediate section 103 of the elongate member 10 and/or the tooth cleaning tip 31 of the second section 102 in such a way that the tooth cleaning plate 21 is kept, in a flat form, at an end of the elongate member 10 to ease an operation of insertion of the tooth cleaning plate 21 of the first section 101 of the elongate member 10 into a slit between teeth of the user, wherein during the operation, the tooth cleaning plate 21 may undergo elastic deformation in accordance with the slit of the teeth of the user in order to carry out tooth picking or cleaning. In addition, if it is necessary, the tooth cleaning tip 31 of the second section 102 of the elongate member 10 may be used, additionally or in combination, to remove stiff detritus trapped around the teeth. As such, convenience and practical use can be enhanced.

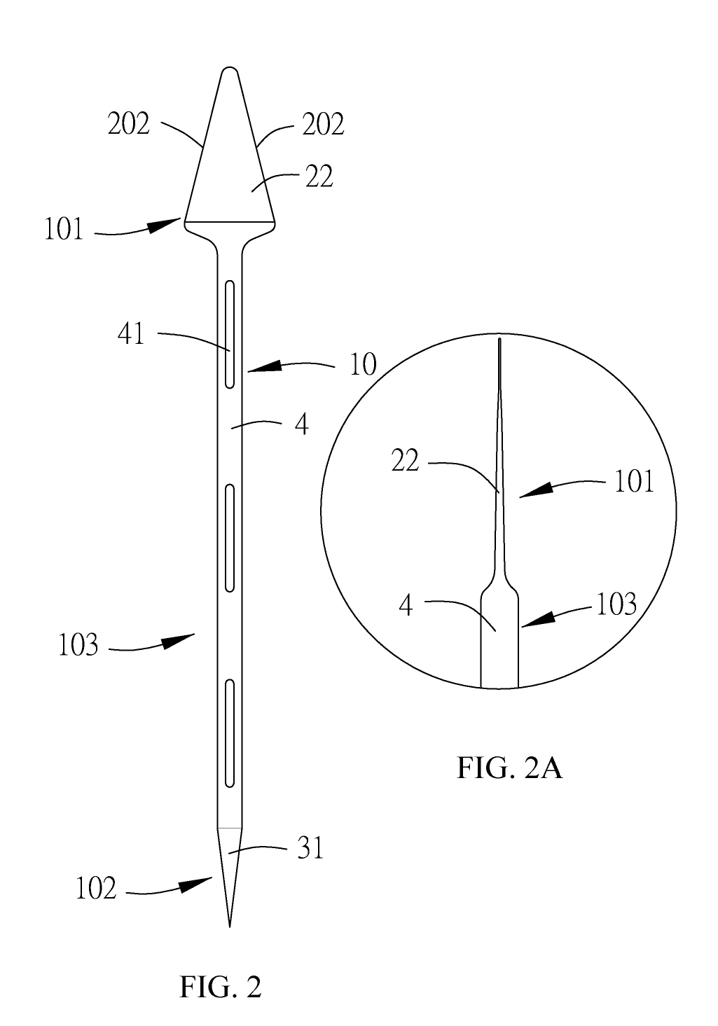

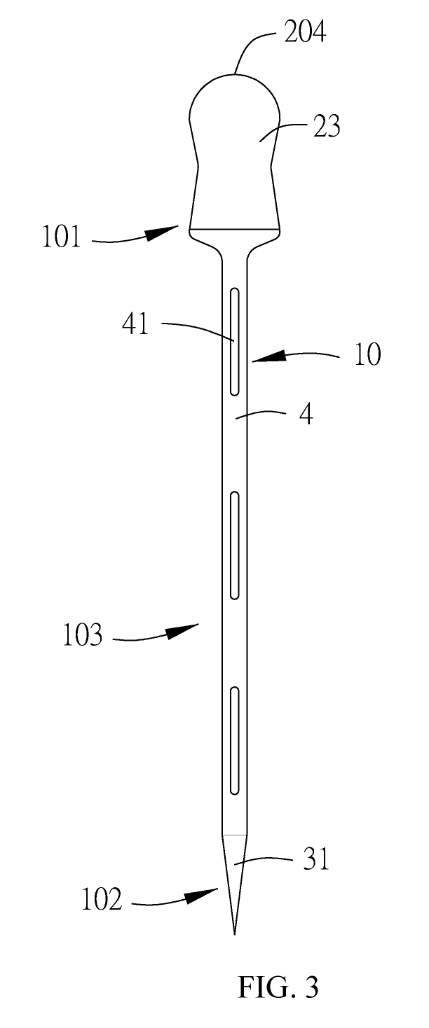

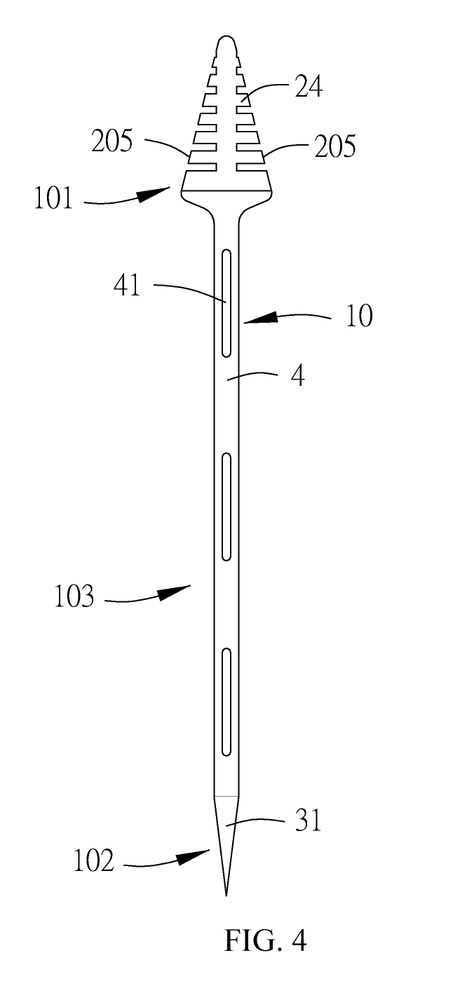

Referring to FIG. 2, as well as FIG. 2A, an illustration is provided to show the tooth cleaning plate 22 can alternatively be a triangular tooth cleaning plate, having two sides each forming a slope edge 202. Referring to FIG. 3, an illustration is provided to show the tooth cleaning plate 23 can alternatively be a partly curved tooth cleaning plate, in such a way that a portion of the tooth cleaning plate 23 that is distant from the intermediate section 103 is configured with a partly curved edge 204. Referring to FIG. 4, an illustration is provided to show the tooth cleaning plate 24 can alternatively be a fish-bone-shaped tooth cleaning plate, having two opposite sides each forming a slope edge 205 having successive corrugations to provide a fish-bone like outline configuration.

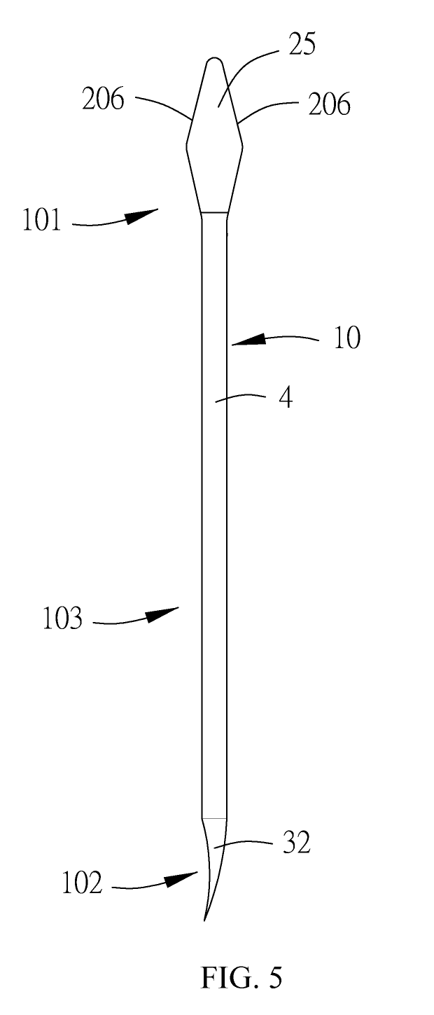

Referring to FIG. 5, an illustration is provided to show the tooth cleaning plate 25 can alternatively be a rhombus tooth cleaning plate, having two opposite sides each configured as a curved edge 206. FIG. 5 also shows the tooth cleaning tip 32 of the second section 102 of the elongate member 10 may be alternatively curved to form an arc-curved tooth cleaning tip.

Referring to FIG. 6, as well as FIG. 6A, an illustration is provided to show the rectangular tooth cleaning plate 21 has two sides that are each formed as a vertical edge 201, and one side portion of the rectangular tooth cleaning plate 21 is configured such that a thickness is reduced in a direction toward an opposite side portion of the rectangular tooth cleaning plate 21. FIG. 6 also shows the tooth cleaning plate 26 of the second section 102 of the elongate member 10 can be configured as a arc-curved tooth cleaning plate, having two opposite sides respectively forming an external arc edge 207 and an internal arc edge 208 and a portion of the tooth cleaning plate 26 that is distant from the intermediate section 103 is formed with a sharp tip edge 209 that connects the external arc edge 207 and the internal arc edge 208 together.

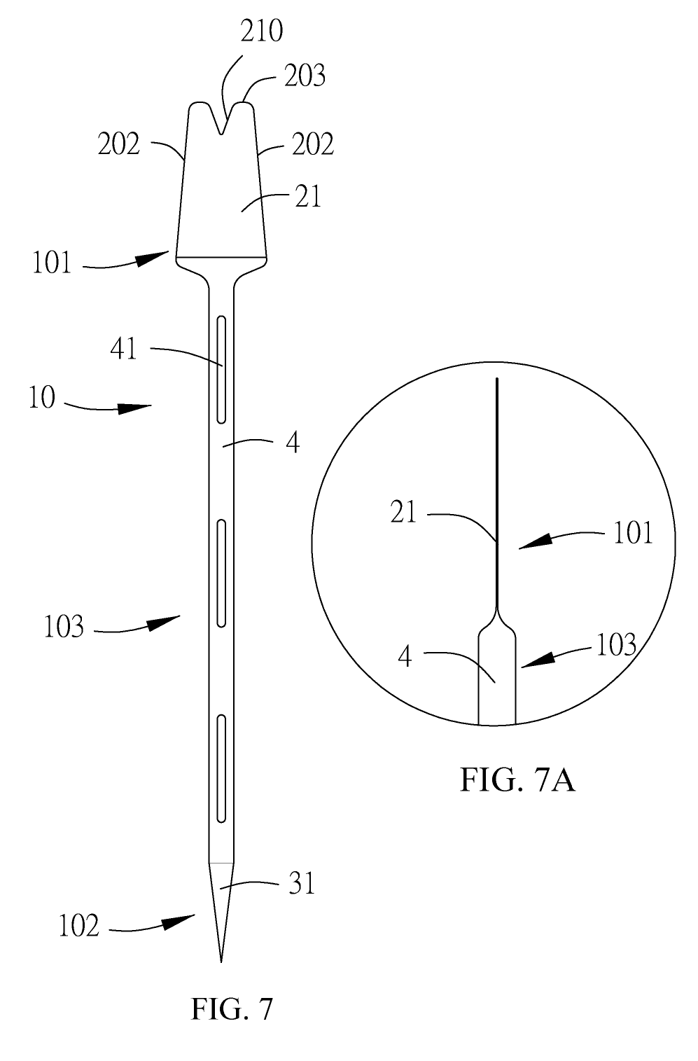

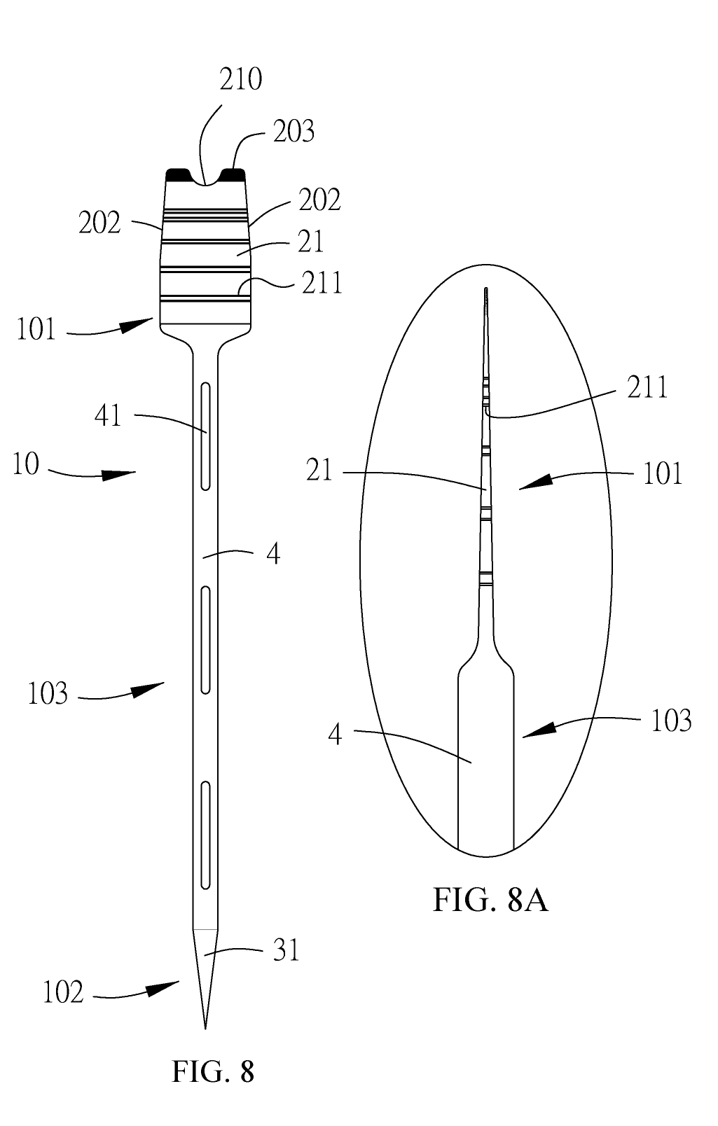

Referring to FIGS. 7 and 8, as well as FIGS. 7A and 8A, an illustration is provided to show the rectangular tooth cleaning plate 21 has two opposite sides that are each formed as a slope edge 202. A portion of the tooth cleaning plate 21 that is distant from the intermediate section 103 (such as the horizontal edge 203 of the rectangular tooth cleaning plate 21) is formed as a notched edge 210. The tooth cleaning plate 21 may have a constant thickness in the entirety thereof. As shown in FIG. 8, the tooth cleaning plate 21 may have a surface or surfaces that are provided with a plurality of thin grooves 211.

Referring to FIG. 9, as well as FIG. 9A, an illustration is provided to show the first section 101 and the second section 102 of the elongate member 100 are respectively formed as tooth cleaning plates 27, 21, the intermediate section 103 of the elongate member 10 is formed as a connection board 5, such that the connection board 5 has two ends that are respectively connected to the tooth cleaning plates 21, 27. The tooth cleaning plate 27 of the first section 101 of the elongate member 100 may be configured as a circular arc tooth cleaning plate, while the tooth cleaning plate 27 is provided, on a surface or surfaces thereof, with a plurality of raised dots 212. The tooth cleaning plate 21 of the second section 102 of the elongate member 100 is formed as a rectangular tooth cleaning plate, and the horizontal edge 203 of the rectangular tooth cleaning plate 21 is formed as a notched edge 210.

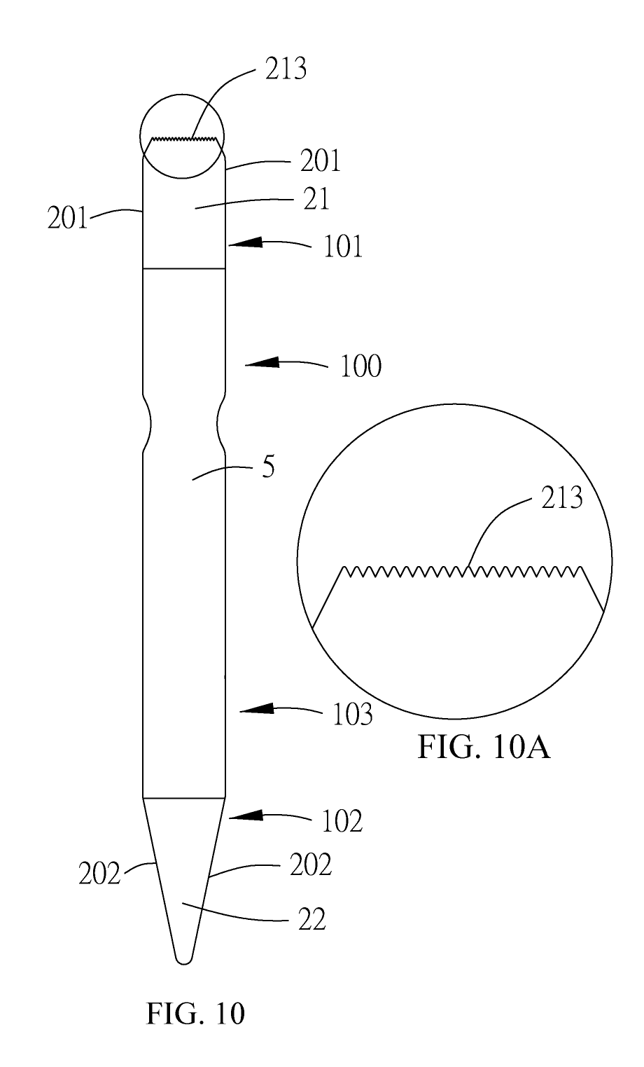

Referring to FIG. 10, as well as FIG. 10A, an illustration is provided to show the tooth cleaning plate 21 of the first section 101 of the elongate member 100 can be formed as a rectangular tooth cleaning plate, and a portion of the tooth cleaning plate 21 that is distant from the intermediate section 103 is provided with a serrated edge 213. The tooth cleaning plate 22 of the second section 102 of the elongate member 100 is formed as a triangular tooth cleaning plate.

The vertical edge 201, the slope edge 202, the horizontal edge 203, the partly curved edge 204, the successively-corrugated slope edge 205, the curved edge 206, the external arc edge 207, the internal arc edge 208, the sharp tip edge 209, the notched edge 210, the thin grooves 211, the raised dots 212, and the serrated edge 213, which have been described above, are provided to help remove or scratch off or clean detritus remaining on or attached to teeth.

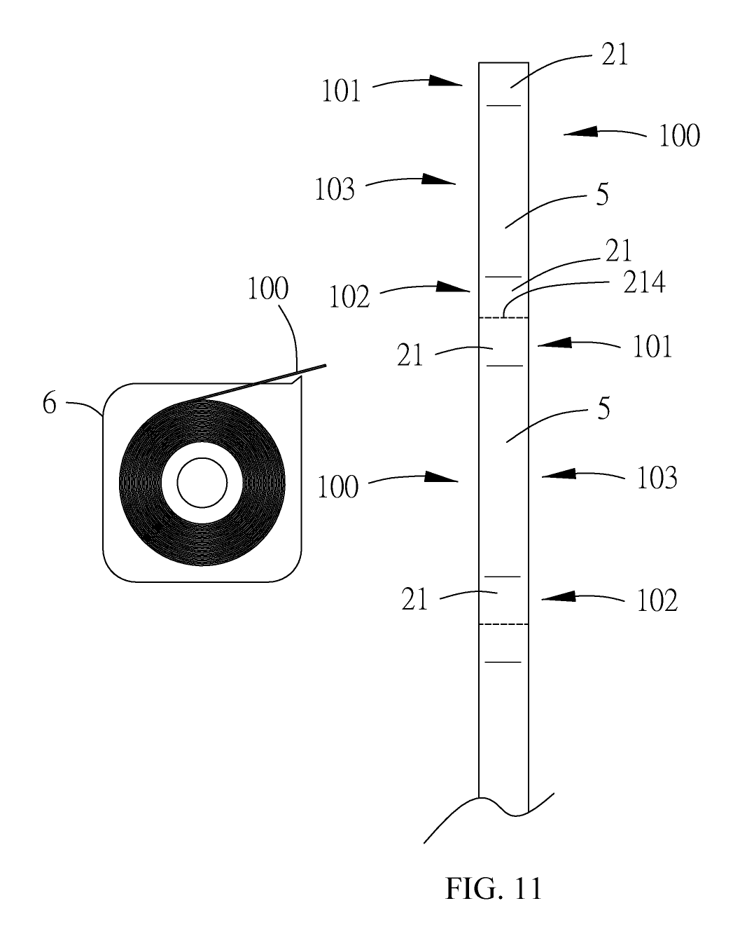

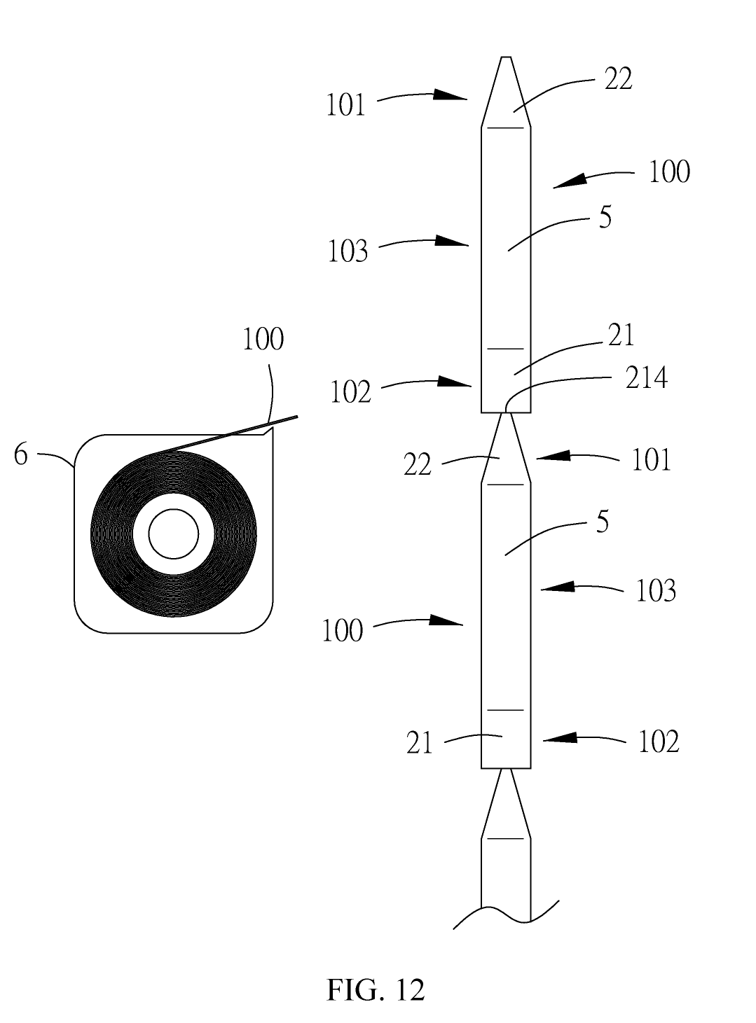

Referring to FIG. 11, an illustration is provided to show the first section 101 and the second section 102 of the elongate member 100 are each provided with a rectangular tooth cleaning plate 21 and the intermediate section 103 of the elongate member 10 is formed as a connection board 5. Further, the elongate member 100 is arranged such that multiple ones thereof are provided with the tooth cleaning plate 21 of the first section 101 and the tooth cleaning plate 21 of the second section 102 of two adjacent ones of the multiple elongate members 100 are connected together by means of a weakened easy-to-break section 214 to form a unitary combined arrangement, whereby the multiple elongate members 100 may be wound up as a roll. Referring to FIG. 12, an illustration is provided to show the first section 101 of the elongate member 100 is formed as a triangular tooth cleaning plate 22, while the second section 102 is provided as a rectangular tooth cleaning plate 21, wherein the triangular tooth cleaning plate 21 and the rectangular tooth cleaning plate 21 of two adjacent ones of the multiple elongate members 100 are connected together by means of a weakened easy-to-break section 214 to form a unitary combined arrangement, whereby the multiple elongate members 100 may be wound up as a roll. As such, the multiple elongate members 100 that are so connected to each other are wound up as a roll that can be received and retained in a wind-up case 6, whereby to use, the outmost one of the elongate members 100 that are wound up as a roll is first pulled out of the wind-up case 6 and then, the outmost elongate member 100 so pulled out can be torn off along the weakened easy-to-break section 214 for use and operation of the tooth cleaning plates 21, 22 of the elongate member 100 to pick and clean teeth. This provides advantages of saving storage space and easy to access and retrieve for use.

It will be understood that each of the elements described above, or two or more together may also fmd a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A tooth cleaning structure, comprising:
an elongate member, which comprises a first section, a second section, and an intermediate section connected between the first section and the second section; and
a tooth cleaning plate, which is provided on the first section, the intermediate section having a thickness that is greater than thicknesses of the first section and the second section, so that the elongate member is elastically deformable and the intermediate section support the tooth cleaning plate to extend out in a flat form at an end of the elongate member.

2. The tooth cleaning structure according to claim 1, wherein the second section is formed with a tooth cleaning tip.

3. The tooth cleaning structure according to claim 2, wherein the tooth cleaning tip is configured as a curved tooth cleaning tip.

4. The tooth cleaning structure according to claim 1, wherein the second section is provided with a tooth cleaning plate, the tooth cleaning plates of the first section and the second section being each formed as one of a flexible tooth cleaning plate and an elastic tooth cleaning plate.

5. The tooth cleaning structure according to claim 1, wherein the intermediate section is formed as one of a connection board and a connection bar.

6. The tooth cleaning structure according to claim 5, wherein the tooth cleaning plate is formed as one of a rectangular tooth cleaning plate, a polygonal tooth cleaning plate, a triangular tooth cleaning plate, a rhombus tooth cleaning plate, a partly curved tooth cleaning plate, a circular arc tooth cleaning plate, a fish-bone-shaped tooth cleaning plate, and an arc-curved tooth cleaning plate.

7. The tooth cleaning structure according to claim 6, wherein a side portion of the rectangular tooth cleaning plate has a thickness that is reduced in a direction toward an opposite side portion of the rectangular tooth cleaning plate.

8. The tooth cleaning structure according to claim 5, wherein a portion of the tooth cleaning plate that is distant from the intermediate section is formed as one of a notched edge and a serrated edge.

9. The tooth cleaning structure according to claim 5, wherein the tooth cleaning plate has a thickness that is reduced from a portion of the tooth cleaning plate that is adjacent to the intermediate section toward a portion of the tooth cleaning plate that is distant from the intermediate section.

10. The tooth cleaning structure according to claim 5, wherein the tooth cleaning plate has a surface that is formed with one of a group of multiple thin grooves and a group of multiple raised dots.

11. The tooth cleaning structure according to claim 5, wherein the elongate member is arranged such that multiple ones thereof are provided with the first section and the second section of two adjacent ones of the multiple elongate members are connected together by means of a weakened easy-to-break section so that the multiple elongate members are windable as a roll.

12. The tooth cleaning structure according to claim 5, wherein a surface of one of the connection board and the connection bar is provided with at least one rib extending in directions toward the first section and the second section.
